(19) United States
(12) Patent Application Publication
(10) Pub. No.: US 2025/0342484 A1
(43) Pub. Date: Nov. 6, 2025

(54) METHOD FOR MONITORING AN ENVIRONMENTAL IMPACT OF A PRODUCT

(71) Applicant: BASF SE, Ludwigshafen am Rhein (DE)

(72) Inventors: Steffen KLOSTERHALFEN, Ludwigshafen am Rhein (DE); Christopher Alec ANDERLOHR, Ludwigshafen am Rhein (DE); Bastian GRUMBRECHT, Ludwigshafen am Rhein (DE); Olaf HUBER, Ludwigshafen am Rhein (DE); Claus TEUBER, Ludwigshafen am Rhein (DE); Omar Osama Mohamed Mohamed ELBADRAWI, Madrid (ES); Raheel AHSAN, Ludwigshafen am Rhein (DE); William Alexander MARVIN, Bridgewater, NJ (US)

(21) Appl. No.: 18/854,107

(22) PCT Filed: Apr. 4, 2023
(86) PCT No.: PCT/EP2023/058883

§ 371 Date: Oct. 4, 2024

(30) Foreign Application Priority Data
Apr. 4, 2022 (EP) 22382319.6

(51) Int. Cl. G06Q 30/018

(52) U.S. Cl. CPC G06Q 30/018

(57) ABSTRACT

The present disclosure provides a system and a computer-implemented method for monitoring and/or controlling a product carbon footprint, PCF, of a product produced in a production process. The method comprises receiving PCF-related data for a first and/or a second point in time; calculating a first PCF of the product at the first point in time and a second PCF of the product at the second point in time based on the PCF-related data; calculating at least a first PCF of an intermediate of the product at a first point in time and a second PCF of the intermediate at a second point in time based on the PCF-related data; identifying at least one influencing factor within the production process for a change in value between the first and second PCF of the product based on the first and second PCF of the intermediate; and outputting the identified at least one influencing factor.

The present invention relates to a method for monitoring and/or controlling an environmental impact of a product. In particular the present invention relates to a computer-implemented method for monitoring and/or controlling a product carbon footprint (PCF) of a product, a system for monitoring and/or controlling a product carbon footprint of a product produced in a production process, a use of an influencing factor within the production process identified by such method, and a non-transitory computer readable data medium related to such method.

The significance of climate protection measures is growing rapidly in the perception of the public, regulators and financial investors. Major companies have announced ambitious short-term CO2 reduction targets, including emissions related to purchased raw materials as, for example, required by the Science-Based Targets Initiative (SBTI). Therefore, transparency on product carbon footprints (PCF) and options to reduce the PCF are increasingly demanded.

PCFs are a measure to determine the amount of greenhouse gas emission caused to produce the respective product. PCFs are an important means to achieve a reduction in greenhouse gas emissions if those products with the lowest PCF are chosen for consumption or for further processing downstream in the value chain. For this purpose, it is of high importance that the reported PCF of any product is as accurate as possible.

PCFs are often calculated by computer programs receiving the required input and subjecting them to an algorithm which calculates the PCF therewith. However, any calculation of a PCF can be influenced by a broad variety of potential impacts, errors, etc., which should be detected quickly and eliminated reliably. For complex production sites in which multiple products are produced in interconnected process chains, identifying an influencer for a changing PCF is a difficult and in practice an often impossible task.

There may, therefore, be a need for providing improved means for monitoring and/or controlling a PCF in terms of its influencing factors. The object is solved by the subject matter of the independent claims, wherein further embodiments are incorporated in the dependent claims.

In a first aspect, there is provided a computer-implemented method for monitoring and/or controlling a product carbon footprint (PCF) of a product produced in a production process. An environmental impact may be measured by a PCF of the product. The method comprises the steps of:
receiving PCF-related data for a first and a second point in time;
calculating a first PCF of the product at the first point in time and a second PCF of the product at the second point in time based on the PCF-related data;
calculating at least a first PCF of an intermediate of the product at a first point in time and a second PCF of the intermediate at a second point in time based on the PCF-related data,
identifying at least one influencing factor within the production process for a change in value between the first and second PCF of the product based on the first and second PCF of the intermediate; and
outputting the identified at least one influencing factor.

In this way, an influencing factor and/or error affecting the PCF calculation can be identified. In particular an influencing factor and/or error affecting the PCF difference between the two points in time can be identified. The identified at least one influencing factor can be used in many ways for and/or during the production of the product. For example, especially if the influencing factor as a source of interference in the production process influencing the product's PCF is at least reduced or eliminated, i.e. corrected, it can be ensured that the PCF of the product at least approaches or matches a target PCF, or is documented for the product in terms of being tied thereto. Further, based on the knowledge of the influencing factor, controlling measures and/or interventions in the production process can be initiated to maintain or not exceed a target PCF, etc. Furthermore, with the knowledge about the influencing factor, there is the possibility to adjust the production in such a way that the PCF value(s) decrease and are reliably low, because the at least one influencing factor, possibly the one with the greatest influence on the PCF of the product and/or with the greatest sensitivity, is known. It is noted that more than one influencing factor affecting the PCF can be identified and/or determined. The method described herein or the influencing factor obtained from it can be used in many ways in the production of the product with regard to influencing the PCF. For example, a certain PCF is usually targeted for the product or must be reached or must not be exceeded, so that the knowledge of the influencing factor influencing the PCF, e.g. also worsening and/or increasing it, can be used at many points in production control. For example, by determining the influencing factor, a production process or production network can be checked for errors in a more targeted manner, where the identified influencing factor may already be the cause of the error or at least one of the reasons for the change or non-compliance with the targeted PCF.

In the context of the present disclosure, the expression “monitoring the production” may be understood broadly, and may refer, for example, to any kind of monitoring of the production process in terms of tracking the product's PCF, validation and/or evaluation of the PCF, ensuring that the product's PCF reaches or not exceeds a target PCF, or the like, by monitoring the production process.

Further, the expression “controlling the production” may refer to any controlling measure or intervention within production, a production network, e.g. a chemical production network, a production step, or the like, that affects the environmental impact parameter and/or the PCF of the product. This may comprise generating a control signal that modifies data within production, e.g. in or via a production control system, an enterprise resource planning systems, or the like. For example, such a controlling measure or intervention may, for example, comprise controlling the production in terms of the PCF of the raw material, e.g. by changing the raw material, a supplier of it, etc., of a process step, e.g. by changing an energy used for the process step, by technical modification of the production step by an modified physical or chemical influence on an input material of the production step, etc. In other words, controlling the production may change one or more production process parameters in the production reality and thus directly or indirectly control the PCF of the product.

However, it is also possible that the “monitoring and/or controlling the production” comprises creating or modifying product information, such as the PCF of the product. For example, it is possible that if it is determined that the influencing factor changes the PCF of the product, the product information, such as the PCF of the product, is modified accordingly. The latter can be done via modifying a corresponding information, e.g. a dataset, in an enterprise resource planning (ERP) system, which manages the corresponding product information and assigns it to the product in a traceable way.

In other words, the method described herein aims to verify that the PCF of the product can be reliably calculated by determining, at least two points in time during production, the PCF of the product. In an example, these points of time are different from each other and may refer to different points of time. Preferably, these points of time are different from each other and may refer to different production stages and/or different points of time. If the calculations of the two PCF of the product differ from each other, there should be at least one influencing factor for these differing PCF of the product. Then the method provides for checking an intermediate upstream of the product to see whether its PCF has also changed.

This can be repeated for each process step in the process chain up to the raw material to determine the at least one influencing factor for the changing PCF and to correct it by controlling intervention or action in the production, process chain and/or production network.

For example, the PCF-related data may be received via an interface, e.g. a data interface, communication interface, etc. As used herein, the “PCF-related data” may be understood as those data that are available, measurable and/or determinable in a production network, a production plant, or, more generally, for the production of a product and are suitable to provide information about the PCF of the product. The PCF-related data can refer to one or more points in time in the production, such as a raw material, a process step, an intermediate, the finished product, etc. For example, the PCF-related data may comprise one or more of process data comprising information about the process steps from the required raw materials to the product, a PCF of each raw material, and energy data comprising information about the energy consumption for each process step. The first and second point in time may be two different points in time during the operation of a production facility, e.g. a production plant, production network, or the like, used to carry out the production process. It is also possible that the first point in time and the second point in time refer to different batches of the same product. For example, the first time point may be set during the production of a first batch of the product and the second point in time may be set during the production of another, second batch during the production of the same product, wherein the first and second point in time may also be set in a respective same link of the production chain, such as considering the same production step, the same intermediate, etc.

Calculating the first PCF of the product at the first point in time and a second PCF of the product at the second point in time based on the PCF-related data may be performed by e.g. a suitable data processor, which may be operatively connected to the interface via which the PCF-related data are received. Further, identifying the at least one influencing factor may be performed by e.g. a suitable data processor, which may be operatively connected to the interface via which the PCF-related data are received. Outputting the identified at least one influencing factor may be performed by e.g. a suitable interface, e.g. a data interface, communication interface, etc.

Further, as used herein, the “influencing factor” to be identified may be any aspect related to the production process, which is able to change or influence the PCF of the product in any way. This can occur from the beginning to the end of the production chain, i.e. the production process.

The major factors which may influence a PCF value are the PCF of raw material(s), the distribution of intermediates, the input output relation of a process step, and the process step itself. For example, regarding the PCF of raw material, there may be one raw material obtained from several suppliers or part of the raw material is obtained from one or multiple suppliers and the rest is produced in-house. Typically, the greenhouse gas emissions differ for each of these sources. Hence, any change in how much of said raw material is obtained from which source influences the PCF. Regarding the distribution of intermediates, for example, an intermediate may be produced at multiple factories and used in multiple subsequent processes. Usually, the greenhouse gas emissions are different for each factory, so any change in the distribution of such intermediates influences the PCF for the products this intermediate is used for. With regard to the input output relation, for example, the ratio of the amount of product produced in this process step and the amount of used raw material in a process step can vary. One reason may be degradation of catalyst over time. The higher this ratio the lower the amount of greenhouse gas emissions per unit of product, hence the PCF in the final product. With regard to the process step, for example, each process step may be subject to changes, for example if hardware is replaced to recycle reaction energy so less heating is needed. Such changes influence the PCF for all products downstream in the value chain.

As used herein, “outputting” the at least one influencing factor may be understood as writing the PCF on a non-transitory data storage medium, display it on a user interface or both. It is also possible to provide the output through an interface to a customer, for example to the customers supply chain system or ERP system. It is also possible to provide the output through an interface to the EPR system of the producer itself from where it can be distributed to where this information is needed.

When the at least one influencing factor is output onto a user interface, the user interface preferably uses graph technology. In this way, it is possible to analyze the contributions along the production process in order to monitor/and or control the production process and thereby minimize the PCF for the products. It is also possible to monitor and/or control changes of the PCF upon changes in the production process. In addition, the output can be used to simulate effects of changes, for example by manually changing certain values and see its effect on the PCF of the product. For example, the effect of replacing a particular raw material by one having lower PCF for each product may be analyzed.

Further, as used herein, the term “PCF” may be understood as a total amount of greenhouse gases emitted or removed in the whole process from extracting natural resources to the product as it leaves a production plant. In the context of the present disclosure, the PCF does not include any greenhouse gas emission later on in the lifetime of a product. For example, for a car, the PCF in the context of the present disclosure is the amount of greenhouse gases emitted to produce the car, but not the emissions caused by using the car once it has left the production plant. The amount of the PCF is typically expressed as carbon dioxide equivalents, so the amount of carbon dioxide with the same effect on global climate as the actually emitted greenhouse gases.

Greenhouse gases comprise carbon dioxide, carbon monoxide, nitrous oxide, methane, ozone, chlorofluorocarbons, hydrofluorocarbons. These can be translated into carbon dioxide equivalents according to IPCC 5th assessment report (cf. standards such as ISO 14067 for PCF of products or the Greenhouse Gas Protocol Product Standard WRI & WBCSD, 2011).

The method described herein can be applied to a wide variety of products which are produced from raw materials. The term “product” as used herein, generally refers to any good and/or finished product which can be sold to others at any point in the value chain. This may include final products for end consumers, for example cars, paints, toys or medicaments; this may also include goods which are typically sold to other companies which further process them, for example steel parts for machines, plastic pellets for extrusion or chemical compounds, for example acrylic acid to produce superabsorbers for diapers; this may also include goods very early in the value chain like crude oil fractions, for example naphtha, agricultural products, for example soy beans, or purified sand for glass production.

The term “raw material” as used in the present disclosure refers to any good which is bought from suppliers and brought to the production plant. A raw material can be on any step along the value chain like the product described above. This means, the product of the one production plant can be the raw material of the other production plant. Raw material can also include very fundamental goods like air, water, natural gas or salt.

An “intermediate” refers to a good, such as a substance, which is neither a raw material nor a product, but is made from raw materials or earlier intermediated and is processed further into other intermediates and finally into the product. The intermediate may be associated with a corresponding process step in which it is produced, used, transported, etc.

A “production plant” as used in the present disclosure is any facility which is able to produce any kind of good which is sold to an end customer or further processed in a different production plant. A production plant can be on one single site or on multiple. If the production plant is in multiple sites, these have to be under common control which is typically the case if they belong to the same company or to affiliated companies. Examples for plants are power plants, steel manufacturing plants, oil producing plants, oil refineries, chemical plants, plants for manufacturing pharmaceuticals, plants for manufacturing construction materials, machine manufacturing plants, automobile manufacturing plants, plants for manufacturing textiles, plants for manufacturing furniture, food production plants, plants for manufacturing consumer electronics such as cell phones, plants for manufacturing and/or processing of paper, such as a printing press.

A “process step” as used herein may be understood as a series of acts onto the raw material(s) which cannot be reasonably separated in time or space. Typically, all acts of one process step take place in one building using a certain dedicated equipment.

The method according to the present invention is particularly useful for production plants which execute interconnected process steps. The term “interconnected” in the context of the present in invention means that at least one process step uses two intermediates of different other process steps or uses one intermediate of different other process steps each producing this intermediate or yields two intermediates which are used in two different other process steps. Hence, preferably, the production plant executes interconnected process steps. Even more preferably, the production plant is a chemical production plant executing interconnected process steps. Often, the interconnected process steps are executed in different factories, maybe on different sites, potentially operated by different group companies.

According to an embodiment, there may be calculated the PCF of more than one intermediate, wherein the production process may contain multiple process steps, and in each process step at least one input material is processed into at least one output material. In other words, a process chain can be divided into further upstream process steps and the PCF of the corresponding intermediate can be calculated there. There, the PCF calculation may be done at a first and second point in time. This allows the influencing factor to be identified more precisely from calculation to calculation, i.e. from intermediate to intermediate, and some influencing factors may be excluded and others focused on.

In an embodiment, the step of calculating of the PCF of the multiple intermediates may be performed over the multiple process steps until a raw material of the product is reached. In other words, all process steps and/or intermediates are taken into account until the respective raw material is reached. This allows the influencing factor to be identified more precisely from calculation to calculation, and some influencing factors can be excluded and others focused on.

According to an embodiment, the at least one influencing factor may be associated with one or more of: a PCF of raw material, a distribution of an intermediate, an input-output relation of a corresponding process step, and a process step itself. As explained above, these are the major factors which influence the PCF and/or its calculation. Further, these influencing factors may be included or derivable from the PCF-related data, knowledge data about the production network, raw materials used, intermediates, process steps, etc. may be obtained from an enterprise resource planning (ERP) system. When the PCFs of these production chain components are considered, e.g., calculated, in comparison to the PCFs of the product as described herein, the PCF can be monitored and controlled, or the production of the product can be controlled, such that the PCF has a desired value or, ideally, a minimum value. For example, the process step may be affected in many ways by the at least one influencing factor and accordingly may be changed based on knowledge of the at least one influencing factor. For example, the process step may be affected or changed by using a recycled input material instead of a newly produced input material of the process step. Or a more efficient production equipment in terms of input/output ratio is used, i.e. instead of a first production equipment a more efficient second production equipment is used, etc. Or, especially if the production step comprises a chemical process, energy released from it is reused or reused further, etc. Also the batch size can change the yield or energy loss or the like.

In an embodiment, identifying the at least one influencing factor may further comprise:
determining, for the at least one intermediate whether or not a change in one or more process parameters, comprising a ratio of raw material, an input/output relation of the process step, and/or a process step itself, has occurred;
wherein if only one of these process parameters has changed, the change of the intermediate is attributed to the determined change of process parameter; and
wherein if more than one of these process parameters have changed, a relative contribution of the individual change is determined and respectively attributed.

For example, knowledge about the production process, which can be obtained from one or more databases and/or an ERP system, can be used to determine at which point the production process or the intermediate of interest has been changed in any way. In the case that only one of the above process parameters has been changed, it can be determined that only this can be causal for a change in the PCF of the product and/or the intermediate, so that this is the influencing factor sought and can be identified accordingly. However, if several of these process parameters have been changed, it can be determined, e.g., calculated, the relative contribution of each process parameter to the change in PCF, thus identifying multiple influencing factors. In any case, to control the production and/or PCF of the product, one or more of these process parameters may be adjusted to adjust or correct and/or optimize the PCF of the product and/or intermediate.

According to an embodiment, identifying the at least one influencing factor may comprise:
determining whether or not the calculated first and second PCF of the intermediate have a change in value in between; and
in case of the first and second PCF of the intermediate having a change in value, determining a ratio and/or sign of this change and comparing this change to the change between the first and second PCF of the product, thereby identifying the at least one influencing factor.

In other words, the change to the influence of the PCF, both if related to the PCF of the product and if related to the PCF of the intermediate, may have a corresponding amount from which the ratio can be determined. Further, each of the determined changes in the PCF may have a sign, wherein the sign of the change in the PCF related to the product and the sign of the change in the PCF related to the intermediate may be the same, i.e. positive and positive or negative and negative, or different, i.e. positive and negative or vice versa, i.e. pointing in the same direction or in different directions. That is, both changes in the PCF may cause its value to increase from the first PCF to the second PCF or to decrease from the first PCF to the second PCF. For example, if the change has occurred between the first and second PCF of the intermediate, the ratio and sign of this change is determined and compared to the change of the PCF, i.e. between the first and second PCF, of the final product. That is, both the respective sign and the respective amount of the change of the PCF may be compared with each other. If the change has the same sign, i.e. both changes (on product level and intermediate level) have a positive (+) or negative (−) sign, it is recorded as a driver for the change and its relative contribution to the final product's PCF change is calculated. Further, the process step to make this intermediate may be analyzed by determining if a difference in the ratio of raw materials, a difference in input/output and a difference in the process itself has occurred. If only one of these factors has changed, the change of the intermediate can be attributed to this change. Otherwise, the relative contribution has to be determined and recorded. Based on this, the influencing factor can be determined.

In an embodiment, if the change between the first and second PCF of the intermediate and the change between the first and second PCF of the product point in a same direction, this may be identified as a driver for the change of the PCF, and the contribution of this driver to the first and/or PCF of the product may be determined. In this way, the influencing factor sought can be narrowed down further and further until it can be determined with a high degree of certainty as the cause of the changed PCF of the product.

According to an embodiment, the method may further comprise a step of determining, from the identified and/or output at least one influencing factor, at least one action associated with an adjustment, preferably decrease, of the PCF of the product to be performed within the production process. In other words, the method allows for determining, via the identified influencing factor that may affect the PCF of the product, especially negatively, measures, i.e. actions, that control and/or correct the PCF of the product towards a desired value. For example, controlling actions can be taken in the production chain to control and/or correct the PCF accordingly. For example, one or more of the process parameters described above, such as the raw material or its sourcing, a process step, an intermediate, etc. may controlled to be changed. The control may be performed by a computer device executing the method, for example, controlling an ERP system or the like, which in turn controls the process chain according to the identified influencing factor.

According to an embodiment, the calculation of the first and/or second PCF of the product or the intermediate may comprise the steps of:
obtaining process data comprising information about the process steps from a raw material to the product;
obtaining a PCF of each raw material;
obtaining energy data comprising information about the energy consumption for each production process step; and
calculating the first and/or second PCF for the product or the intermediate taking into account the process data, the PCF of each raw material and the energy data.

For example, calculating the PCF of the product or the intermediate comprises summing the PCF of each raw material used in a particular process step as contained in the process data. If a process step requires an intermediate from a different process step, the sum of the carbon footprint of the raw material for this earlier process step is determined and used as input for the later process step. It may be necessary to repeat this if the earlier process step again uses an intermediate of an even earlier process step. If one process step yields more than one intermediate, for example two or three, it is necessary to share the PCF of the raw materials among these intermediates. The share for each intermediate should reflect the raw material usage for each intermediate. In some cases, two intermediates are formed at the same amount, so the PCF of the raw materials can be equally shared among them. In other cases, significantly more of one intermediate is formed than the other, for example 90% of intermediate 1 and 10% of intermediate 2. The PCF should be shared accordingly. Hence, preferably, in the method of the present invention determining the PCF involves calculating the PCF for an intermediate produced in a preceding process step and using the car-bon footprint of the intermediate as input for the calculation of the PCF of a subsequent process step. In particular, in interconnected production processes, the calculation of the PCF can be facilitated by subdividing it into analogous calculation parts, one for each process step.

The process data may comprise information about which by-products are obtained in which amount. Some process steps may not produce any by-products, such as the assembly of steel parts. In this case, the process data does not comprise information about by-products. However, many process steps produce by-products. A “by-product” in the context of the present disclosure refers to any good which is unavoidably obtained in a process step but cannot be used in a different process step. Sometimes, a by-product can be recycled, i.e. be subjected to another process step or multiple process steps to obtain a raw material or an intermediate which can be used as reagent in a process step. However, in some cases, there is no economically feasible use for the by-product. In this case, the by-product has to be disposed. It can, for example, be burned in an incineration. If the incineration is part of the production plant, the thermal and/or electrical energy regained has to be taken into account.

The process data may comprise information about which intermediate or intermediates are obtained in each process step and at which yield. The “yield” in the context of the present invention refers to the percentage of outcome from a particular process step relative to the theoretical maximum. If the yield is 100%, for example if ingredients are mixed into a formulation, the process data does not have to comprise information about the yield.

However, the yield can be below 100% if there are losses in a process step. In chemical reactions, the yield is typically below 100%, be-cause of side reactions and losses upon purifications. In other processes, yields can also be be-low 100%, for example if steel parts are cut or drilled, the chips may cause a loss unless they can be reused.

The process data may comprise information about any direct greenhouse gas emissions by the process step. Such direct greenhouse gas emissions often stem from a chemical reaction of the raw materials which either contain greenhouse gases or generate greenhouse gases during the process step, for example by heating. A typical example is cement production in which carbon dioxide evolves from heating the raw materials, in particular from heating limestone. The information about direct greenhouse gas emissions usually contains the information which green-house gas is emitted at which amount. The amount can be given relative to the amount of raw materials or relative to the amount of product or intermediate of the respective process step. The latter can be derived from the former by multiplying with the yield of the process step.

In the easiest case, one or multiple raw materials may be processed in one process step to arrive at the product. An example could be that certain cables and plugs are the raw materials which are assembled to form a cable tree as a product which is sold to car manufacturers. In most cases, however, the production processes are more complicated. Multiple raw materials are processed into various intermediates which are processed into various products, wherein one raw material can be used to produce more than one intermediate and one intermediate may be used to pro-duce more than one product. In such a situation, the final PCF of one product become dependent on the amount of other products produced at the production plant. Hence, typically the process data comprise the information which reagents are required at which amounts for each process step for all products having at least one reagent or intermediate in common. For many production plants, the process data comprise the information which reagents are required at which amounts for each process step for at least two products having at least one reagent or intermediate in common. For complex production plants the process data comprise the information which reagents are required at which amounts for each process step for at least five or at least ten products having at least one reagent or intermediate in common.

The process data is typically obtained, received, etc. through an interface, e.g. a data interface, communication interface, etc. The process data may be obtained from e.g. a production plant. It can be obtained through an interface to a local or a remote database. Preferably, the process data is obtained through an interface to an enterprise resource planning (ERP) system. In this way, the process data may be obtained from the ERP system. The ERP system may obtain the information from the production plant. In this case, the process data is obtained from the production plant via an ERP system. In this way, the process data is instantly updated once any change in the production plant or its surrounding occurs. Depending on the ERP system “instantly” typically means in less than or equal to one day, preferably less than or equal to six hours, in particular less than or equal to one hour. A typical example of such a change would be that the production plant receives insufficient reagent from a different factory and has to use an external supply instead. Such an external supply usually has a different PCF than the internal intermediate, hence changing the PCF of the product produced in the production plant. Another advantage of an ERP is system is that the data is standardized and validated, i.e. it is reliable and typically does not need further validation.

An “ERP system” in the context of the present invention shall have its common meaning. A typical ERP system provides an integrated and continuously updated view of core business processes using common databases maintained by a database management system. ERP systems typically track business resources such as cash, raw materials, production capacity and the status of business commitments: orders, purchase orders, and payroll. The applications that make up the system typically share data across various departments such as those responsible for manufacturing, purchasing, sales, accounting, that provide the data.

If the production plant comprises multiple group companies, for example in different countries, the different group companies often use separate ERP systems. If an intermediate produced by one group company is shipped to another group company using this intermediate in another process step, the ERP systems have to treat such operations as external transactions for legal reasons. However, for the purpose of the present invention, such data has to be consolidated to identify intermediates produced by one group company and used by a different group company. Such information may be accessible from the ERP systems or may require other data sources, such as a shared database. Hence, preferably the process data is obtained through an interface to ERP systems of different group companies, wherein the process data is consolidated to identify intermediates produced by one group company and used by a different group company.

Energy data typically comprises the amount of energy consumed, the energy form and its origin. The amount is often given as specific energy per piece or mass of the product or intermediate of that respective process step. The amount can be positive, i.e. if the energy is consumed, or negative, i.e. if the process step produces energy. An example for the latter is the production of sulfuric acid from sulfur. Sulfur is reacted with oxygen releasing thermal energy which can be used in a different process step. The energy form includes electricity, thermal energy, such as warm water or steam, cooling or fossil fuels such as gas or petrol. In the case of fossil fuels, these are also raw materials, but their PCF only refers to the greenhouse gas emission for producing these. However, the exhaustion of carbon dioxide upon burning these has to be taken into account as well. The origin of the energy refers to source where the energy is taken from. For example, thermal energy can originate from power plants, from other process steps or from solar panels. Hence, the origin can have a considerable effect on the greenhouse gas emission associated with the energy consumption. It can be useful to average energy data over a certain period of time, for example over a period of 3 years, to compensate for example seasonal variations. The energy data is usually transformed into PCFs by taking into account the energy sources and their specific greenhouse gas emissions.

The energy data is typically obtained, received, etc. through an interface. The energy data can be obtained through an interface to a local or a remote database or an ERP system. The energy data may hence be obtained from an ERP system. Usually, the energy data is obtained through an interface to more than one database. It is therefore often necessary to convert the information retrieved from different databases into a single format to allow further processing.

The energy data can also be available directly from the energy source, for example a power plant having sensors attached to a processing system which provides its information through an interface. The production plant usually also has sensors to determine the amount of energy consumed by the power plant. Often, a production plant has multiple sensors providing data about the energy consumption of a certain process step or certain equipment. Hence, the energy data may be obtained from the production plant. In many production plants, however, such information, namely the energy data, is first transferred to an ERP system from which it can be obtained. In another example the sensor may be adapted for detecting a certain amount of greenhouse gas. This means, the sensors for determining the energy consumption and/or greenhouse gas release transfer their data to the ERP system from which it can be obtained.

Commonly, in particular for larger production plants, multiple energy sources are available. For example, the production plant is on a larger site which has a power plant, such as a gas power plant or solar panels, and in addition the production plant can obtain energy from a public power grid. Depending on the energy source the contribution to the PCF can be quite different, for example essentially no contribution if the energy is received from a solar panel or a wind turbine or a significant contribution if the energy is received from a public power grid which provides energy from coal power plants. Therefore, preferably, the energy data also comprises information about the source the energy is received from. This information is typically obtained from sensors in the production plant or in a central power supply facility. The energy data preferably contains information of the carbon emissions caused by each energy source from which energy is received. In this way, it is possible to calculate the contribution of the energy to the PCF.

The energy data may not be readily available for each process step, but may only be available in more aggregated form, for example the energy consumption of a factory in which multiple process steps are executed. In this case, the energy consumption for each process step has to be derived from such aggregated data. This can be achieved by determining the share of the energy consumption of each process step in the aggregated data. To this end, a suitable basis is defined, for example, in a simple approach, based on the share of the production volume, for example measured in physical quantity such as mass, of each of the process steps. A more precise way of allocating the energy consumption is by using data about the energy-related production costs at the product level, obtained for example from an ERP system.

In an embodiment, one or more of the process data, the PCF of each raw material and the energy data may be obtained from a production plant via an ERP system. For most raw materials, the PCF may be obtained from the supplier provides or from public or private databases. Usually, different suppliers provide the same raw material with different PCF due to differences in its production process or logistics. Therefore, preferably, the PCFs of a raw material are obtained for each supplier together with an identifier of the supplier. This information can then be used to calculate the PCF of that particular raw material depending on how much of the raw material is used from which supplier. The result can be taken into account for determining the PCF in the method of the present invention. In rare cases, no PCFs are available. In this case, the PCF has to be estimated, for example by comparison to very similar products on the market. The PCF of each raw material is typically obtained through an interface. The PCF of each raw material can be obtained through an interface to a local or a remote database or an ERP system, in particular its supply chain module. The PCF of each raw material may hence be obtained from an ERP system. Usually, the PCF of each raw material is obtained through an interface to more than one database. It is therefore often necessary to convert the information retrieved from different databases into a single format to allow further processing. In particular, the PCFs obtained from databases have to be attributed to the raw material, i.e. the identification of a raw material in the database has to be translated to the identification of the raw material of the process data used in the method described herein.

According to an embodiment, the PCF of the raw material may be obtained for each supplier together with an identifier of the supplier and wherein determining the PCF takes into account the amount of raw material from a particular supplier and its associated PCF. For example, the information about the supplier may then be used to calculate the PCF of that particular raw material depending on how much of the raw material is used from which supplier. The result can be taken into account for determining the PCF in the method of the present invention. In rare cases, no PCFs are available. In this case, the PCF may be estimated, for example by comparison to very similar products on the market.

A second aspect is directed to the use of the at least one influencing factor obtained by the method of the first aspect to monitor and/or control the production of a product. The influencing factor generally indicates at which point of the production process the PCF or its calculation is influenced, in particular the PCF is increased. Thus, in general, validation of the PCF can be achieved by identifying and/or determining the at least one influencing factor. By identifying the influencing factor, appropriate measures or actions can be taken to adjust, preferably reduce, the PCF of the product or bring it toward a target value. For example, from the knowledge about the at least one influencing factor, possibly with the additional knowledge about the production process, e.g. its raw materials, intermediates, process steps, etc., an overview can be generated showing the influence of the at least one influencing factor on the production process as a whole and/or for each individual process step within the process chain. This can be done, for example, via a user interface, in particular a graphical user interface (GUI), whereby the production can be controlled. For example, amendments in the production chain can be determined that take into account or eliminate an influencing factor and/or lower the PCF. Amendments to the production process can also be made using the e.g. ERP system, i.e. production can be controlled in an at least partially automated manner in such a way that a PCF is reduced or a specific PCF is achieved.

In a third aspect, there is provided a non-transitory computer readable data medium storing a computer program including instructions for executing steps of the method according to the first aspect. Computer readable data medium include hard drives, for example on a server, USB storage device, CD, DVD or Blue-ray discs. The computer program may contain all functionalities and data required for execution of the method according to the present invention or it may provide interfaces to have parts of the method processed on remote systems, for example on a cloud system.

According to a fourth aspect, there is provided a system for monitoring and/or controlling a product carbon footprint (PCF) of a product produced in a production process. Unless explicitly described differently hereafter, the description above relating to the method including preferred embodiments also applies to the system. The system can be a computing device, for example, a computer, tablet, or smartphone, or any other suitable computing device. In at least some embodiments, the computing device may have a communication interface and/or network connection in order to communicate with other computing devices, such as servers or a cloud network.

The system comprises an input interface configured to receive PCF-related data for a first and/or a second point in time. The system further comprises a processor configured to calculate a first PCF of the product at the first point in time and a second PCF of the product at the second point in time based on the PCF-related data, to calculate at least a first PCF of an intermediate of the product at a first point in time and a second PCF of the intermediate at a second point in time based on the PCF-related data, and to identify at least one influencing factor within the production process for a change in value between the first and second PCF of the product based on the first and second PCF of the intermediate. Further, the system comprises an output interface, configured to output the identified at least one influencing factor for further processing.

According to an embodiment, the output interface may comprise a user interface configured to display the identified at least one influencing factor. The user interface is preferably configured to display the influencing factor and/or PCF of the product and each contribution, preferably comprising the contribution of the raw materials, the contribution of the energy, and the contribution of the direct emissions of each process step. Preferably, the user interface uses graph technology. The user interface may provide an overview of each process step, its raw materials and energy required, the connection with other process steps. The user interface may also provide the PCF for each process step, in particular it may display the PCF originating from the raw materials, from the energy consumption, and from the direct greenhouse gas emissions separately and in aggregated form.

Preferably, the system is adapted to receive updated data at any time and can update the output in real time, which usually means within less than a few minutes, preferably within less than a minute, for example within 1 to 30 seconds.

It is noted that embodiments of the invention are described with reference to different subject-matters. In particular, some embodiments are described with reference to method-type claims whereas other embodiments are described with reference to apparatus or device-type or system-type claims. However, a person skilled in the art will gather from the above and the following description that, unless otherwise notified, in addition to any combination of features belonging to one type of subject-matter also any combination between features relating to different subject-matter is considered to be disclosed with this application. Further, all features can be combined providing synergetic effects that are more than the simple summation of the features.

These and other aspects of the present disclosure will become apparent from and elucidated with reference to the embodiments described hereinafter.

Exemplary embodiments of the invention will be described in the following with reference to the following drawings.

FIG. 1 illustrates in a schematic block diagram a system for monitoring and/or controlling a product carbon footprint (PCF) of a product produced in a production process according to the present disclosure.

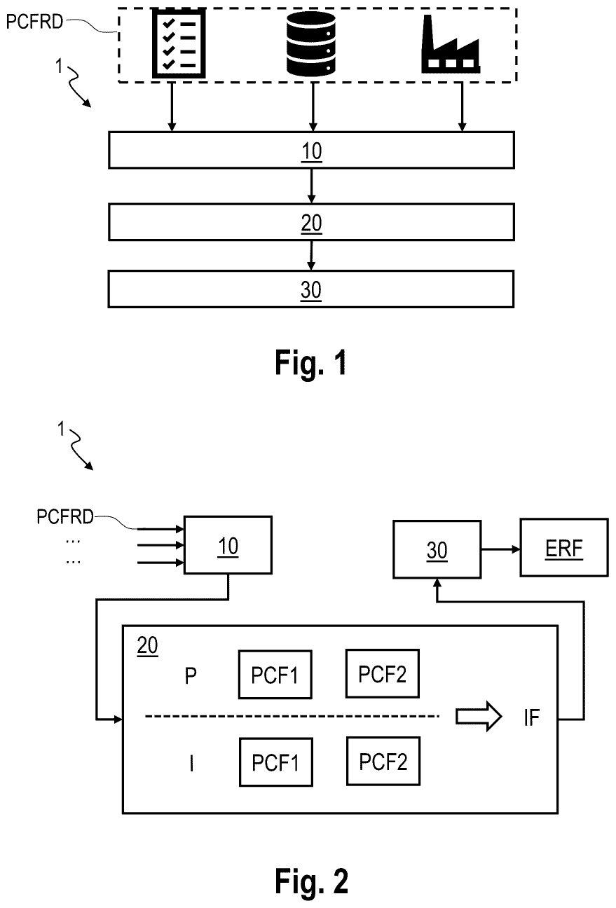

FIG. 2 illustrates in a schematic block diagram a system and principle for monitoring and/or controlling a product carbon footprint (PCF), of a product produced in a production process according to the present disclosure.

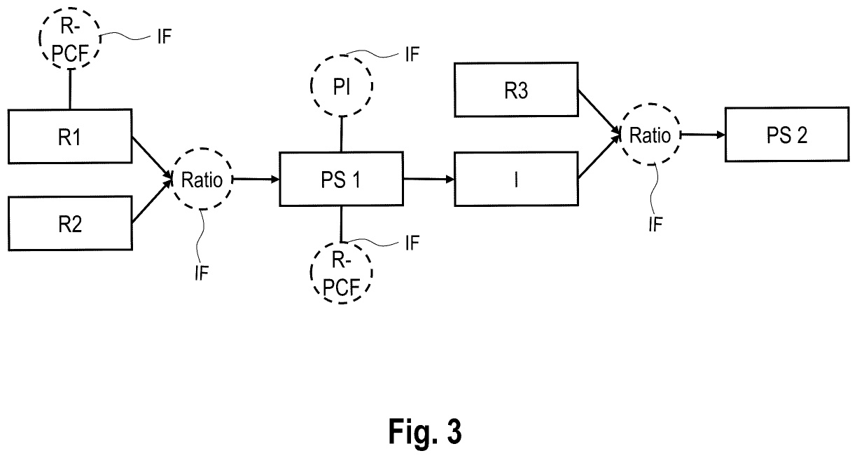

FIG. 3 illustrates in a schematic block diagram an exemplary production process in which the system and method of the present disclosure can be applied.

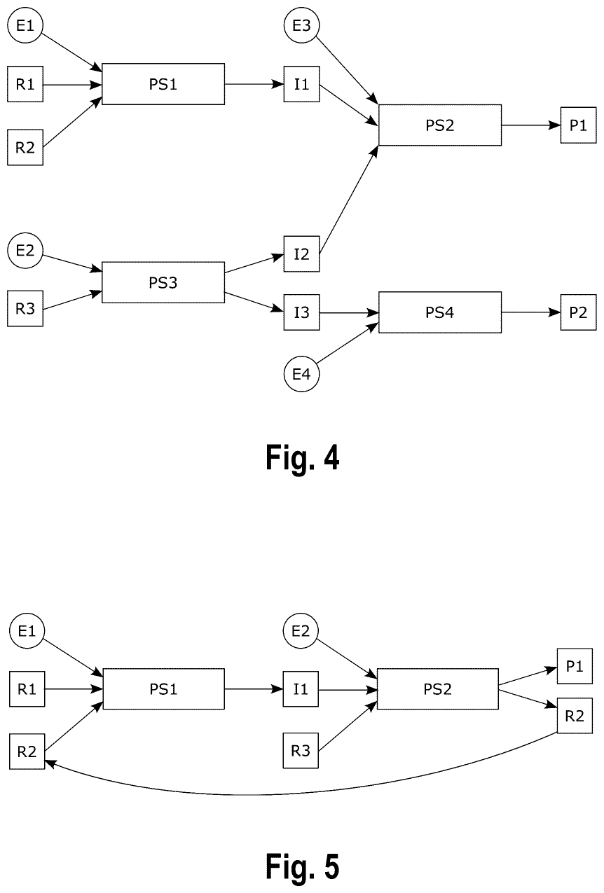

FIG. 4 illustrates in a schematic block diagram an exemplary production process in which the system and method of the present disclosure can be applied.

FIG. 5 illustrates in a schematic block diagram an exemplary production process in which the system and method of the present disclosure can be applied.

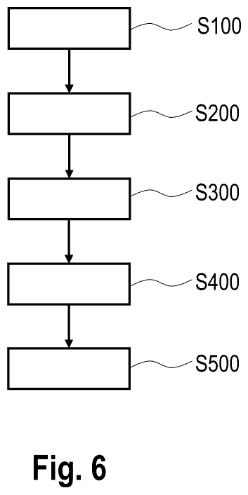

FIG. 6 illustrates in a flow chart a computer-implemented method for of determining an onset and/or onset time of a plant disease in agriculture according to the present disclosure.

The drawings are merely schematic representations and serve only to illustrate the invention. Identical or equivalent elements are consistently provided with the same reference signs.

FIG. 1 illustrates in in a schematic block diagram a system 1 configured to monitor and/or control a product carbon footprint (PCF) of a product produced in a production process. The system 1 is any suitable computing device and comprises an input interface 10, a data processor 20, and an output interface 30. The processor 20 is operatively connected to each one of the input interface 10 and the output interface 30.

The input interface 10 is e.g. a data interface, communication interface, or the like, configured to receive PCF-related data PCFRD for a first and/or a second point in time. In at least some embodiments, the PCF-related data PCFRD may be those data available at the respective point in time or may be generally associated therewith. For this purpose, the input interface 10 is operatively connected to, for example, one or more suitable data sources, such as an enterprise resource planning system (ERF), a supplier database, or the like, which may collect and/or provide the PCF-related data PCFRD. For example, the PCF-related data PCFRD may comprise one or more of process data comprising information about the process steps from the required raw materials to the product, a PCF of each raw material, and energy data comprising information about the energy consumption for each process step. The first and second point in time may be two different points in time within the production process, different links in the production chains, or the like.

The processor 20 is configured, e.g. by executing a respective computer program, to calculate a first PCF of the product “P” at the first point in time and a second PCF of the product at the second point in time based on the PCF-related data. The first and second PCF are referred to in the drawings as PCF1 and PCF2 in the (final) product level “P” (see e.g. FIG. 2). Further, the processor 20 is configured, e.g. by executing a respective computer program, to additionally calculate at least a first PCF of an intermediate I of the product P at a first point in time and a second PCF of the intermediate I at a second point in time based on the PCF-related data. The first and second PCF of the intermediate I are referred to in the drawings as PCF1 and PCF2 in the intermediate level “I” (see e.g. FIG. 2). In other words, at least two PCFs are calculated at different times at different stages of the production process, namely for the product and for at least one of its intermediates. Further, the processor 20 is configured, e.g. by executing a respective computer program, to identify at least one influencing factor IF within the production process for a change in value between the first and second PCF of the product P based on the first and second PCF of the intermediate I. In other words, by taking into account the PCF of an intermediate upstream of the final product, it is determined whether this or a related process step causes an observed change in the PCF of the product. According to an embodiment, the at least one influencing factor may be associated with one or more of: a PCF of raw material, a distribution of an intermediate, an input-output relation of a corresponding process step, and a process step itself.

The output interface 30 is any suitable data interface, communication interface or the like, configured to output the identified at least one influencing factor IF for further processing. The output interface 30 may, for example, comprise or be operatively connected to a user interface for displaying the at least one influencing factor. However, it may also be connected to a production control system, e.g. the ERF or the like, so that the system 1 may control it based on the at least one influencing factor IF, thereby controlling the production process accordingly to eliminate or at least reduce the at least one influencing factor IF, for example by controlling the production parameters, such as raw material, energy consumption, etc., to control the PCF of the product accordingly.

Optionally, the processor 20 is configured to determine, for the at least one intermediate whether or not a change in one or more process parameters, such as a ratio of raw material, an input/output relation of the process step, and/or a process step itself, has occurred. If only one of these process parameters has changed, the change of the intermediate I is attributed to the determined change of process parameter. However, if more than one of these process parameters have changed, a relative contribution of the individual change is determined and respectively attributed.

Further optionally, the processor 20 is configured to determine whether or not the calculated PCF1 and PCF2 of the intermediate I have a change in value in between. In case of the PCF1 and PCF2 of the intermediate I having a change in value, the processor 20 is configured to determine a ratio and/or sign of this change and compare this change to the change between the PCF1 and PCF2 of the product1 to identify the at least one influencing factor. Thereby, if the change between the PCF1 and PCF2 of the intermediate I and the change between PCF1 and PCF2 of the product P point in a same direction, this is identified as a driver for the change, and its contribution to the PCF1 and PCF2 of the product P is determined.

FIG. 2 illustrates the system 1 shown in FIG. 1 in more detail. As described above, the input interface 10 is connected to receive at least the PCF-related data PCFRD, which may comprise one or more of process data comprising information about the process steps from the required raw materials to the product, a PCF of each raw material, and energy data comprising information about the energy consumption for each process step, etc. The PCF-related data PCFRD is utilized by the processor 20 to calculate the PCF1 and PCF2 for the product P, e.g. on the level of the final product P, and to determine whether there is a change between the PCF1 and PCF2. Particularly, if there is a change between the PCF1 and PCF2, meaning that there is an inconsistency within the PCF determination for the product, the processor 20 further utilizes the PCF-related data PCFRD to determine the at least one intermediate of the product and calculate the PCF1 and PCF2 for the intermediate I, e.g. on the level of the intermediate I. As described above, the processor 20 is further configured to identify the at least one influencing factor IF for the change in the PCF1 and PCF 2 for the product P based on the PCF1 and PCF2 of the intermediate I of the product P. The identified influencing factor IF is then output via the output interface 30, which may comprise a user interface, or the like, or may be connected to a production control system, such as an ERF or the like.

FIG. 3 illustrates in a schematic block diagram an exemplary production process and/or a schematic block diagram of a production network to which the system 1 described above can be applied. In FIG. 3, some exemplary influencing factors IF influencing the PCF or its calculation, i.e. the calculation of the PCF1 and/or PCF2, are indicated by circles with dashed lines, wherein these influencing factors are not limited herein. The exemplary production process of FIG. 1 starts with two exemplary raw materials R1 and R2, which may be obtained from different suppliers. In this level of the production process, the PCF of the raw material, which is designated by R-PCF can be determined, e.g. obtained from the ERF, from a supplier database, or the like, or may be calculated from PCF-related data, etc. For example, a ratio of the raw materials R1 and R2 may form another influencing Factor IF, which may determine by the processor 20. The raw materials R1 and R2 are processed in a first process step PS1 producing an intermediate I from the raw materials R1 and R2. This intermediate I, which can also be sourced externally, is further processed in a subsequent process step PS2, wherein it may be combined with a further raw material R3, which may be obtained from a further, third supplier. There, again the ratio between the intermediate I and the raw material R3 may form another influencing factor IL.

FIG. 4 illustrates another example of a common production process for a product P. Again, the raw materials are denoted as R1, R2 and R3, the products are denoted as P1 and P2, the intermediates, i.e. all goods which are neither raw materials nor products, are denoted as I1, I2 and I3, the energy required for each production process are denoted as E1, E2, E3 and E4, the process steps are denoted PS1, PS2, PS3 and PS4. Raw materials R1 and R2 are processed in a first process step PS1 to produce intermediate I1 using the energy E1. In the next process step PS2, intermediate I1 is processed with intermediate I2 using the energy E3 to arrive at product P1. Intermediate I2 is also made within the same production plant in process step PS3 by processing raw material R3 using the energy E2. In process step PS3, another intermediate I3 is obtained which can be further processed in another process step PS4 using energy E4 to the other product P2. It can easily be recognized that the raw materials R1, R2 and R3 as well as the energies E1, E2 and E3, in particular the emissions generated when producing the energies E1, E2 and E3, have an impact on the PCF of P1. However, also the usage of I3 has an impact, because if the demand for product P2 changes, either the input of I3 cannot be used completely because of too low demand for product P2, a higher percentage of the PCF of R3 and the emission due to E2 will have to be attributed to I2 and consequently P1. Therefore, it is usually necessary to provide complete information about all raw materials and all process steps in a production plant, at least in case that there are connections between different chains of process steps from raw materials to the products.

The system 1, particularly the processor 20, is configured to determine each of raw materials R1, R2 and R3, each of the process steps PS1, PS2, PS3 and PS4, each of the energy E1, E2, E3 and E4 required for each production process, and/or each of the intermediate I1, I2 and I3 as the at least one influencing factor IL. Accordingly, the system 1 is configured to control the production process in these terms to control the PCF of the product P based on the influencing factor IL, e.g. through controlled intervention in the production system and/or production process.

FIG. 5 shows another example which can particularly occur in the chemical industry. Raw materials R1 and R2 are processed in a first process step PS1 to produce intermediate I1 using the energy E1. In the next process step PS2, intermediate I1 and raw material R3 are processed using the energy E2 to arrive at product P1 while the reagent R2 is also obtained. R2 can be reused in process step PS1, so a cycle is formed. In this situation, the process data has to contain information on how much of R2 is used from a supplier and how much recycled R2 obtained in process step PS2 is used.

Again, the system 1, particularly the processor 20, is configured to determine each of raw materials or reagent R1 and R2, each of the process steps PS1 and PS2, each of the energy E1 and E2 required for each production process, and/or each of the intermediate I1, as the at least one influencing factor IL. Accordingly, the system 1 is configured to control the production process in these terms to control the PCF of the product P based on the influencing factor IL, e.g. through a controlled intervention in the production system and/or production process.

FIG. 6 illustrates in a flow chart a method for a computer-implemented method for monitoring and/or controlling a product carbon footprint (PCF) of a product produced in a production process. The method may be carried out by the system 1 as described above and/or may be applied to the exemplary production processes shown in FIG. 3 to FIG. 5, in order to identify the at least one influencing factor IL for the PCF of the product.

In a step S100, there is received PCF-related data PCFRD for a first and/or a second point in time. The PCF-related data PCFRD may be received e.g. via the input interface 10 of the system 1 as described above. For example, the PCF-related data PCFRD may be received from an ERP system or any other suitable data source as described above.

In a step S200, there is calculated a first PCF of the product at the first point in time and a second PCF of the product at the second point in time based on the PCF-related data. The calculation of the first PCF, which is also referred to herein as PCF1 for the product P, and the calculation of the second PCF, which is also referred to herein as PCF 2 for the product P, may be carried out by the processor 20 of the system 1 as described above.

In a step S300, there is calculated at least a first PCF of an intermediate I of the product P at a first point in time and a second PCF of the intermediate at a second point in time based on the PCF-related data PCFRD. The calculation of the first PCF, which is also referred to herein as PCF1 for the intermediate I, and the calculation of the second PCF, which is also referred to herein as PCF 2 for the intermediate I, may be carried out by the processor 20 of the system 1 as described above.

In a step S400, there is identified at least one influencing factor IL within the production process for a change in value between the first and second PCF of the product based on the first and second PCF of the intermediate. In other words, the step above step S300 is performed, in particular, when a change is determined or detected between the PCF1 and PCF2 of the product P from step S200. In this case, the PCF1 and PCF2 of the intermediate I are determined or calculated. Step S400 can then be performed to determine which factor within the production process is causal or contributory to this change in PCF value. The identification or determination of the at least one influencing factor IL may be carried out by the processor 20 of the system as described above.

In a step S500, the identified at least one influencing factor IF is output for further processing. For example, this can be output via the output interface 30, which may comprise a user interface and/or may be operatively connected to a production control system, an ERF, or the like, where the identified at least one influencing factor IF may be used to control the production process in terms of controlling the PCF of the product P.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

1. A computer-implemented method for monitoring and/or controlling a product carbon footprint, PCF, of a product produced in a production process, the method comprising:
receiving PCF-related data for a first and a second point in time;
calculating a first PCF of the product at the first point in time and a second PCF of the product at the second point in time based on the PCF-related data;
calculating at least a first PCF of an intermediate of the product at a first point in time and a second PCF of the intermediate at a second point in time based on the PCF-related data,
identifying at least one influencing factor within the production process for a change in value between the first and second PCF of the product based on the first and second PCF of the intermediate; and
outputting the identified at least one influencing factor.

2. The method of claim 1, wherein the PCF of more than one intermediate is calculated, and the production process contains multiple process steps, wherein in each process step at least one input material is processed into at least one output material.

3. The method of claim 2, wherein calculating of the PCF of the multiple intermediates is performed over the multiple process steps until a raw material of the product is reached.

4. The method of claim 1, wherein the at least one influencing factor is associated with one or more of: a carbon footprint of raw material, a distribution of an intermediate, an input-output relation of a corresponding process step, and a process step itself.

5. The method of claim 1, wherein identifying the at least one influencing factor comprises:
determining, for the at least one intermediate whether or not a change in one or more process parameters, comprising a ratio of raw material, an input/output relation of the process step, and/or a process step itself, has occurred,
wherein if only one of these process parameters has changed, the change of the intermediate is attributed to the determined change of process parameter, and
wherein if more than one of these process parameters have changed, a relative contribution of the individual change is determined and respectively attributed.

6. The method of claim 1, wherein identifying the at least one influencing factor comprises:
determining whether or not the calculated first and second PCF of the intermediate have a change in value in between; and
in case of the first and second PCF of the intermediate having a change in value, determining a ratio and/or sign of this change and comparing this change to the change between the first and second PCF of the product, thereby identifying the at least one influencing factor.

7. The method of claim 6, wherein if the change between the first and second PCF of the intermediate and the change between the first and second PCF of the product point in a same direction, this is identified as a driver for the change, and its contribution to the first and/or PCF of the product is determined.

8. The method of claim 1, further comprising:
determining, from the identified and/or output at least one influencing factor, at least one action associated with an adjustment of the PCF of the product to be performed within the production process.

9. The method of claim 1, wherein the calculation of the first and/or second PCF of the product or the intermediate comprises:
obtaining process data comprising information about the process steps from a raw material to the product;
obtaining a carbon footprint of each raw material;
obtaining energy data comprising information about the energy consumption for each production process step; and
calculating the first and/or second final product-related PCF taking into account the process data, the carbon footprint of each raw material and the energy data.

10. The method of claim 9, wherein the one or more of the process data, the carbon footprint of each raw material and the energy data is obtained from a production plant via an enterprise resource planning system.

11. The method of claim 9, wherein the carbon footprint of the raw material is obtained for each supplier together with an identifier of the supplier and wherein determining the carbon footprint takes into account the amount of raw material from a particular supplier and its associated carbon footprint.

12. A method to monitor and/or control production of a product comprising using the at least one influencing factor obtained by the method of claim 1.

13. A non-transitory computer readable data medium storing a computer program including instructions for executing steps of the method according to claim 1.

14. A system for monitoring and/or controlling a product carbon footprint, PCF, of a product produced in a production process, the system comprising:
an input interface configured to receive PCF-related data for a first and a second point in time;
a processor configured to:
calculate a first PCF of the product at the first point in time and a second PCF of the product at the second point in time based on the PCF-related data;
calculate at least a first PCF of an intermediate of the product at a first point in time and a second PCF of the intermediate at a second point in time based on the PCF-related data,
identify at least one influencing factor within the production process for a change in value between the first and second PCF of the product based on the first and second PCF of the intermediate; and
an output interface, configured to output the identified at least one influencing factor.

15. The system of claim 14, wherein the output interface comprises a user interface configured to display the identified at least one influencing factor.

16. The method of claim 8, wherein the adjustment is a decrease.

17. The method of claim 10, wherein the carbon footprint of the raw material is obtained for each supplier together with an identifier of the supplier and wherein determining the carbon footprint takes into account the amount of raw material from a particular supplier and its associated carbon footprint.
